(19) United States
(12) Patent Application Publication
(10) Pub. No.: US 2010/0175615 A1
(43) Pub. Date: Jul. 15, 2010

(54) APPARATUS FOR PRODUCING HOT-DIP METAL COATED STEEL STRIP

(75) Inventors: Hiroyuki Fukuda, Tokyo (JP); Gentaro Takeda, Tokyo (JP); Hideyuki Takahashi, Tokyo (JP); Tadashi Nara, Tokyo (JP); Keisuke Ono, Tokyo (JP); Shinji Goto, Tokyo (JP); Nobutomo Inenaga, Tokyo (JP)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: JFE STEEL CORPORATION, Tokyo (JP)

(21) Appl. No.: 12/676,157

(22) PCT Filed: Aug. 28, 2008
(86) PCT No.: PCT/JP2008/065927

§ 371 Date: Mar. 11, 2010

(30) Foreign Application Priority Data
Sep. 5, 2007 (JP) 2007-229781

(51) Int. Cl. B05C 3/02; B05C 11/06

(52) U.S. Cl. 118/63

(57) ABSTRACT

An apparatus for producing a hot-dip metal coated steel strip configured to control the thickness of a coating metal by blowing a gas from wiping nozzles to a steel strip continuously drawn from a coating bath, the wiping nozzles being arranged above the coating bath and facing the respective surfaces of the steel strip, and including rectifying plates arranged on the respective sides of the steel strip located above submersed support rolls and below the surface of a molten metal while not being in contact with the steel strip and the submersed support rolls, each of the rectifying plates having a roll-covering portion and a steel-strip-facing portion, each of the roll-covering portions being arranged to cover ¼ or more of the periphery of a corresponding one of the submersed support rolls near to the molten metal surface, each of the steel-strip-facing portions arranged above a corresponding one of the submersed support rolls and facing the steel strip, and the steel-strip-facing portions of the rectifying plates being connected to the respective steel-strip-side ends of the roll-covering portions.

### RELATED APPLICATIONS

This is a §371 of International Application No. PCT/JP2008/065927, with an international filing date of Aug. 28, 2008 (WO 2009/031599 A1, published Mar. 12, 2009), which is based on Japanese Patent Application No. 2007-229781, filed Sep. 5, 2007, the subject matter of which is incorporated by reference.

### TECHNICAL FIELD

This disclosure relates to an apparatus for producing a hot-dip metal coated steel strip in a hot-dip metal coating process, the apparatus being configured to reduce splashing of a molten metal.

### BACKGROUND

A gas wiping device is typically arranged in a continuous hot-dip metal coating process and the like, as shown in FIG. 1, the gas wiping device being configured to control the amount of a molten metal coated (coating weight) on a steel strip 2 by blowing a pressurized gas from gas wiping nozzles 3 to the steel strip to remove an excess amount of the molten metal, the gas wiping nozzles 3 extending in the direction of the width of the steel strip and being arranged on both sides so as to face the steel strip 2, such that the molten metal sticking to the surface of the steel strip uniformly has a predetermined thickness in the transverse and longitudinal directions, the blowing step being performed after the steps of immersing the steel strip 2 in the molten metal 7 filled in a coating bath 8, changing the travel direction using a sink roll 6, and drawing the steel strip 2 in the vertical direction.

To stabilize the travel position of the steel strip in the gas wiping portion, submersed support rolls 5 are usually arranged above the sink roll 6 and below the molten metal surface. In the case of performing alloying treatment, support rolls 4 outside the bath are arranged above the gas wiping nozzles 3, as needed.

The gas wiping nozzles 3 are usually longer than the width of the steel strip, i.e., each extend beyond the ends of the steel strip 2 in the width direction, to correspond steel strips with various widths and the displacement in the width direction in drawing the steel strip. In the case of using such a gas wiping device, splashing, in which the molten metal dropping toward the lower portion of the steel strip is spattered, due to the turbulence of a jet impinging on the steel strip 2 occurs, leading to a reduction in the surface quality of the steel strip.

To increase the volume of production in the continuous process, the threading speed may be increased. In the case where in the continuous hot-dip metal coating process, the coating weight is controlled by the gas wiping method, the initial amount of the molten metal applied to the steel strip immediately after the steel strip passes through the coating bath is increased with increasing line speed due to the viscosity of the molten metal. Thus, to control the coating weight within a certain range, the wiping gas pressure is forced to be set at a higher level. This results in a significant increase in the amount of splash, thereby reducing the surface quality.

To overcome the foregoing problems, a method for reducing an excess amount of molten metal sticking to a steel strip between a coating bath and wiping nozzles to some extent to reduce the initial amount of the molten metal sticking to the steel strip immediately after the steel strip passes through the coating bath is disclosed as follows.

Japanese Unexamined Patent Application Publication No. 2004-76082 discloses an apparatus including molten-metal-reducing members arranged on both sides of a steel strip and between support rolls and gas wiping nozzles in a coating bath so as to face the steel strip, in which an excess amount of molten metal is removed, and then gas wiping is performed to control the coating thickness. Each of the molten-metal-reducing members preferably has a rectangular shape, a shape having an entry portion in which the distance between the member and the corresponding surface of the steel strip increases with decreasing distance from the lower end of the member, or a columnar shape. The molten-metal-reducing members are most preferably located so as to cross the surface of the molten metal.

Japanese Unexamined Patent Application Publication No. 2005-15837 discloses a hot-dip metal coating apparatus including a blade wiping device having blades arranged on both sides of the steel strip and tilted with respect to the steel strip, the blade wiping device being located on and above the surface of a molten metal, in which an excess amount of molten metal is removed, and then gas wiping is performed to control the coating thickness. A portion of each blade closest to the steel strip has a round shape with a diameter of 30 mm.

In the method disclosed in Japanese Unexamined Patent Application Publication No. 2004-76082, however, in the case where the molten-metal-reducing members are located above the molten metal surface or to cross the molten metal surface, the apparatus has the following disadvantages: The molten metal finally removed by gas wiping flows down to form pools between the steel strip and the molten-metal-reducing members. The reduction effect is low because of a short distance between the pools and the gas wiping nozzles. Furthermore, the solidified metal sticking to the molten-metal-reducing members adheres to the steel strip, thereby forming surface defects. Meanwhile, also in the case where the molten-metal-reducing members are arranged in the molten metal, since each of the molten-metal-reducing members a shape in which the distance between the member and the steel strip increases with decreasing distance from the lower end of the member, the flow path narrows gradually. Thus, the flow of the molten metal concentrates to locally increase the flow velocity thereof, thereby disadvantageously reducing the reduction effect.

In the method disclosed in Japanese Unexamined Patent Application Publication No. 2005-15837, even in the case of using the tilted blades with the round-shaped portion closest to the steel strip, pools are disadvantageously formed on upper ends in the same way as in Japanese Unexamined Patent Application Publication No. 2004-76082. The reduction effect is low because of a short distance between the pools and the gas wiping device.

Consequently, in the methods disclosed in Japanese Unexamined Patent Application Publication Nos. 2004-76082 and 2005-15837, the effect of reducing the initial coating weight immediately after the steel strip passes through the molten metal is not sufficient. Hence, the effect of suppressing the occurrence of splashing of the molten metal at the gas wiping portion is not sufficient.

It could therefore be helpful to provide an apparatus for stably producing a hot-dip metal coated steel strip having excellent surface appearance, the apparatus reducing the initial coating weight immediately after the steel strip passes through a molten metal and suppressing the occurrence of splashing during threading at both normal and high speeds.

### SUMMARY

We discovered that, in the case where a molten-metal-reducing member for removing an excess amount of molten metal is arranged between a sink roll and a gas wiping portion, the best position of the molten-metal-reducing member arranged is below the molten metal surface because an excess amount of the molten metal cannot be reduced due to the short distance between the pools and the gas wiping portion as described above. However, the molten-metal-reducing member having a known cross section provides a low effect of reducing the molten metal. To effectively reduce the amount of the molten metal sticking to the steel strip drawn from the molten metal, flow analysis was made in detail with a model apparatus for simulating flows of the molten metal around the molten-metal-reducing member using water. Our analysis showed that accompanying flows flowing in the travel direction of the steel strip near the steel strip surfaces affect the amount of molten metal sticking to the steel strip and that the smaller flows is more effective.

We thus conducted studies on, for example, the shape of the molten-metal-reducing member for removing an excess amount of the molten metal sticking to the steel strip and conceived rectifying plates serving as the molten-metal-reducing member on the basis of the findings, each of the rectifying plates (baffle plates) having a portion covering ¼ or more of the periphery of a corresponding one of the submersed support rolls near to the surface of the molten metal and having a portion facing the steel strip. We thus provide:
(1) An apparatus for producing a hot-dip metal coated steel strip, the apparatus being configured to control the thickness of a coating metal by blowing a gas from wiping nozzles to a steel strip continuously drawn from a coating bath, and the wiping nozzles being arranged above the coating bath and facing the respective surfaces of the steel strip, includes rectifying plates (baffle plates) arranged on the respective sides of the steel strip located above submersed support rolls and below the surface of a molten metal while being not in contact with the steel strip and the submersed support rolls, each of the rectifying plates (baffle plates) having a roll-covering portion and a steel-strip-facing portion, each of the roll-covering portions being arranged so as to cover ¼ or more of the periphery of a corresponding one of the submersed support rolls near to the molten metal surface, each of the steel-strip-facing portions being arranged above a corresponding one of the submersed support rolls and facing the steel strip, and the steel-strip-facing portions of the rectifying plates being connected to the respective steel-strip-side ends of the roll-covering portions.
(2) In the apparatus for producing a hot-dip metal coated steel strip described in item (1), the minimum distance between the roll-covering portion of each rectifying plate and a corresponding one of the submersed support rolls is 100 mm or less, and the minimum distance between the steel-strip-facing portions of the rectifying plates and the steel strip is 100 mm or less.
(3) In the apparatus for producing a hot-dip metal coated steel strip described in item (1) or (2), the distance between the top of the steel-strip-facing portion of each rectifying plate and the surface of the molten metal is 100 mm or less.
(4) In the apparatus for producing a hot-dip metal coated steel strip described in any one of items (1) to (3), Lr*Sr≧S*L is satisfied, where S [mm] represents the minimum distance between the steel strip and the rectifying plates, Sr [mm] represents the minimum distance between each submersed support roll and a corresponding one of the rectifying plates, Lr [mm] represents the arc length of the periphery of each submersed support roll near to the molten metal surface, the periphery being covered with a corresponding one of the rectifying plates, and L [mm] represents the length of the steel-strip-facing portion of each rectifying plate.

Since the rectifying plates are arranged in the molten metal, each of the rectifying plates having the portion covering ¼ or more of the periphery of the corresponding submersed support roll near to the molten metal surface and the portion facing the steel strip, the coating thickness can be adjusted after removing an excess amount of the molten metal sticking to the steel strip, thereby significantly reducing the amount of splashing. In the related art, an increase in threading speed results in a significant increase in the amount of splashing. In contrast, we suppress the occurrence of splashing even at a significantly increased threading speed. Therefore, our apparatus produces a surface defect-free hot-dip metal coated steel strip with high productivity.

### BRIEF DESCRIPTION OF THE DRAWINGS

FIG. 1 shows a known apparatus for producing a hot-dip metal coated steel strip.

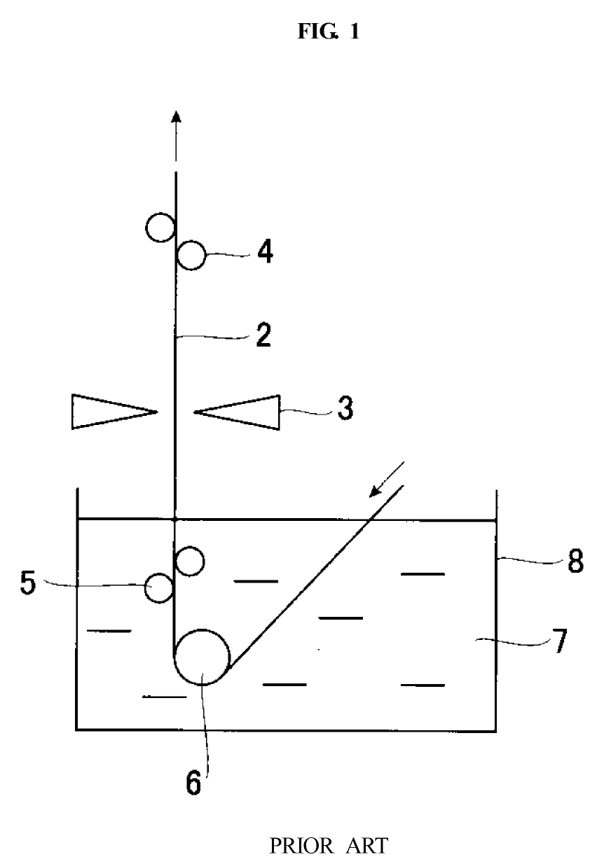

FIG. 2 shows an example of our apparatus for producing a hot-dip metal coated steel strip.

FIG. 3 illustrates cross-sectional shapes of rectifying plates arranged in an apparatus for producing a hot-dip metal coated steel strip and flows of a molten metal around the rectifying plates.

FIG. 4 illustrates the arrangement of a rectifying plate.

FIG. 5 illustrates cross-sectional shapes of rectifying plates arranged in an apparatus for producing a hot-dip metal coated steel strip.

FIG. 6 illustrates a cross-sectional shape of a rectifying plate arranged in an apparatus for producing a hot-dip metal coated steel strip.

### DETAILED DESCRIPTION

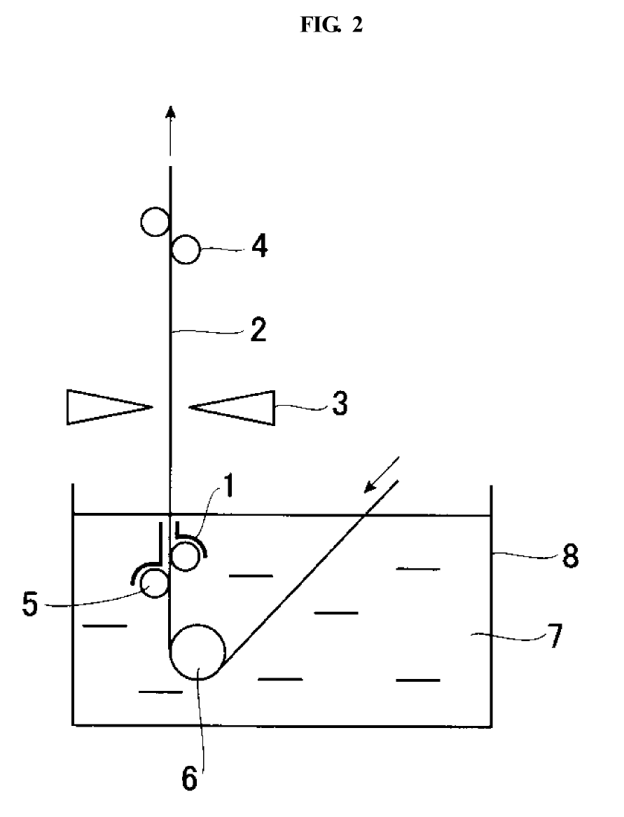

Selected examples will be described with reference to the attached drawings. In the following figures, elements having the same functions as the elements shown in the explained figure are designated using the same reference numerals, and redundant descriptions are not made. FIG. 2 shows an apparatus for producing a hot-dip metal coated steel strip. In FIG. 2, reference numeral 1 denotes rectifying plates. The rectifying plates 1 are arranged on the respective sides of a steel strip 2, above submersed support rolls 5, and below the surface of the molten metal.

Each of the rectifying plates 1 has a portion (roll-covering portion) covering the periphery of a corresponding one of the submersed support rolls 5 while not being in contact with the corresponding submersed support roll 5 and a portion (steel-strip-facing portion) facing the steel strip while not being in contact with the steel strip. Each of the steel-strip-facing portions is arranged above a corresponding one of the roll-covering portions. The bottom of each steel-strip-facing portion is connected to the steel-strip-side end of the corresponding roll-covering portion. Each of the submersed support rolls 5 is rotated in such a manner that the rotation direction of a portion thereof closest to the steel strip is equal to the travel direction of the steel strip.

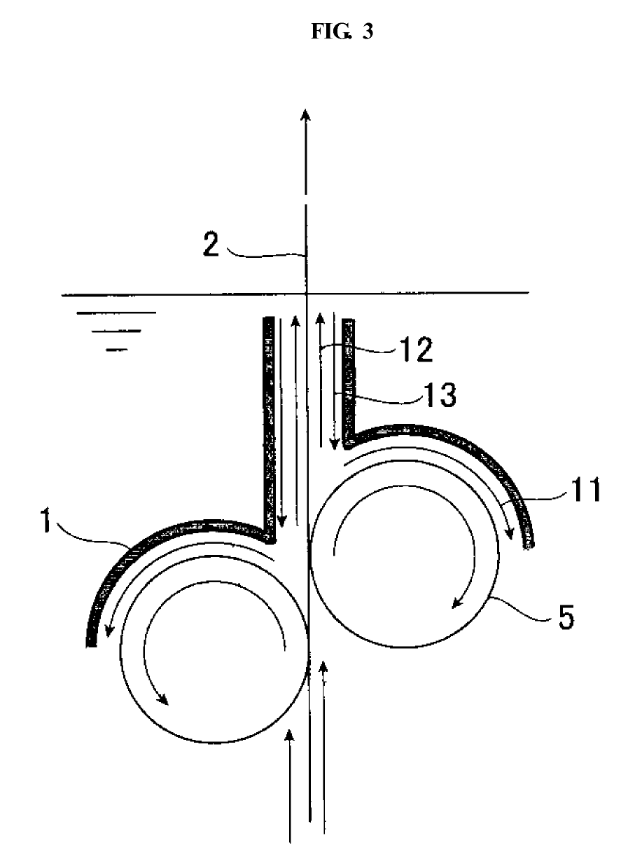

FIG. 3 illustrates exemplary cross-sectional shapes of the rectifying plates 1 arranged in the apparatus shown in FIG. 2 and flows of the molten metal around the rectifying plates 1. Reference numeral 11 denotes flows caused by the submersed support rolls 5. Reference numeral 12 denotes flows caused by the steel strip 2. Reference numeral 13 denotes flows induced by the flows 11.

The arrangement of the rectifying plates 1 above the submersed support rolls 5 below the molten metal surface results in the generation of the flows 11 due to the submersed support rolls 5 between the submersed support rolls 5 and the rectifying plates 1. The generation of the flows 11 results in the generation of the forced flows 13 between steel strip 2 and the rectifying plates 1 in the direction opposite to the travel direction of the steel strip 2 even when the flows 12 are generated, thus significantly reducing the accompanying flows 12. This results in a reduction in an excess amount of molten metal sticking to the steel strip drawn from the coating bath.

To sufficiently generate the accompanying flows 13 induced by the flows 11 generated by the rotation of the submersed support rolls 5, the flows 13 propagating between the steel strip 2 and the rectifying plates 1 in the direction opposite to the travel direction of the steel strip 2, the portion of each rectifying plate 1 covering the corresponding submersed support roll 5 needs to have a length sufficient to cover ¼ or more (25% or more) of the periphery of a corresponding one of the submersed support rolls 5 near to the molten metal surface. The longer portion covering the corresponding submersed support roll 5 improves the effect as long as the portion is not in contact with the steel strip. That is, the portion may cover ¼ or more (25% or more) of the periphery of the corresponding submersed support roll 5 near to the molten metal surface and less than 100% of the periphery of the corresponding submersed support roll 5 near to the molten metal surface and is not in contact with the steel strip 2. The length of each rectifying plate 1 covering the corresponding submersed support roll 5 defined here is the length of the arc of the periphery of the submersed support roll 5 on which the rectifying plate 1 is projected when the rectifying plate 1 is projected toward the center of the submersed support roll 5 in a cross section perpendicular to the center line of the submersed support roll 5.

The distance between each rectifying plate 1 and a corresponding one of the submersed support rolls 5 is preferably 100 mm or less and more preferably 50 mm or less. A distance exceeding 100 mm weakens the accompanying flows 11, so that the flows 13 are not generated, thereby reducing the effect of decreasing an excess amount of molten metal sticking to the steel strip. A distance of 50 mm or less results in the suppression of the flows reducing an excess amount of the molten metal sticking to the steel strip, thereby further enhancing the effect of reducing an excess amount of the molten metal sticking to the steel strip. The distance between each rectifying plate 1 and the corresponding submersed support roll 5 may be reduced as long as the rectifying plate 1 is not in contact with the submersed support roll 5. The distance between each rectifying plate 1 and the corresponding submersed support roll 5 may be larger than 0 mm.

The distance between the rectifying plates 1 and the steel strip 2 is preferably 100 mm or less and more preferably 50 mm or less. At a distance exceeding 100 mm, the flows 13 propagating in the direction opposite to the travel direction of the steel strip 2 do not affect the accompanying flows 12 caused by the travel of the steel strip 2, thus reducing the effect of decreasing an excess amount of the molten metal sticking to the steel strip. A distance of 50 mm or less results in the suppression of the flows caused by the steel strip, thus further enhancing the effect of reducing an excess amount of the molten metal sticking to the steel strip. The distance between the rectifying plates 1 and the steel strip 2 may be reduced as long as the rectifying plates 1 are not in contact with the steel strip 2. The distance between each rectifying plate 1 and the corresponding submersed support roll 5 may be larger than 0 mm.

It is not necessary to maintain a constant distance between each rectifying plate 1 and the corresponding submersed support roll 5. Also, it is not necessarily to maintain a constant distance between the rectifying plates 1 and the steel strip 2. Thus, the shape of the portions of the rectifying plates 1 covering the submersed support rolls 5 is not limited to an arc. Furthermore, the portions of the rectifying plates 1 facing the steel strip 2 may not be arranged in parallel with the steel strip.

The top of each rectifying plate 1 is preferably located at a position 100 mm or less apart from the molten metal surface. If the distance from the molten metal surface exceeds 100 mm, the accompanying flows 12 due to the travel of the steel strip 2 develops above the rectifying plates 1, thereby reducing the effect of decreasing an excess amount of the molten metal sticking to the steel strip. If the top of at least one of the rectifying plates 1 is located above the molten metal surface, the excess molten metal is wiped to attach the top of the at least one of the rectifying plates 1, thus disadvantageously damaging the steel strip.

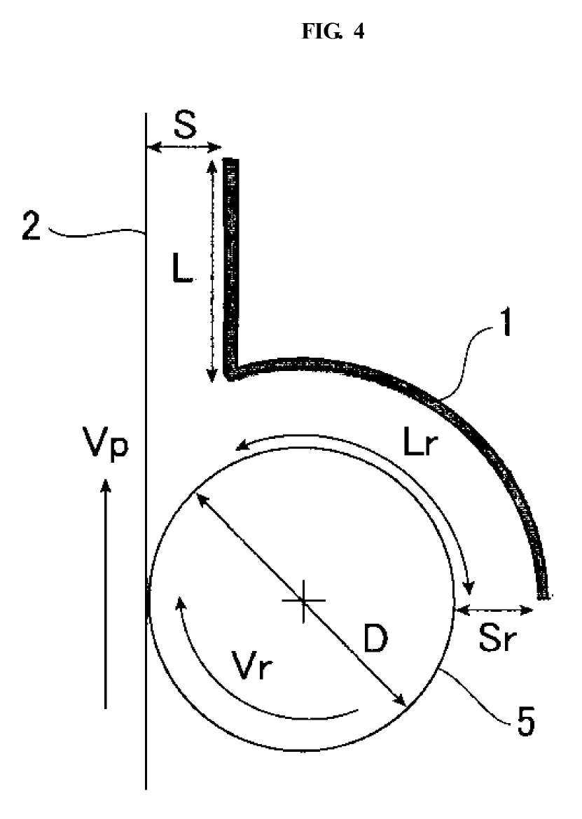

Referring to FIG. 4, with respect to the rectifying plates 1 each having the submersed-roll-covering portion in the form of an arc with the same center as the corresponding submersed support roll 5 and having the steel-strip-facing portion having a shape parallel to a surface of the steel strip, the reduction ability of the rectifying plates has been studied. We found that to reduce an excess amount of the molten metal sticking to the steel strip drawn from the coating bath, more preferably, the following equation (1) is satisfied:

Lr*Sr≧S*L (1)

where S [mm] represents the distance between the steel strip 2 and the rectifying plates 1, Sr [mm] represents the distance between each submersed support roll 5 and a corresponding one of the rectifying plates 1, Lr [mm] represents the arc length of the periphery of each submersed support roll 5 near to the molten metal surface, the periphery being covered with a corresponding one of the rectifying plates 1, and L [mm] represents the length of the portion of each rectifying plate 1 parallel to the steel strip 2.

The circumferential speed Vr of the support rolls synchronizes with the speed Vp of the steel strip. Each of the distance S between the steel strip 2 and the rectifying plates 1 and the distance Sr between each submersed support roll 5 and the corresponding rectifying plates 1 is 100 mm or less. The arc length Lr of the periphery of each submersed support roll 5 near to the molten metal surface, the periphery being covered with a corresponding one of the rectifying plates 1, is πD/4 or more.

An increase in the left-hand side of the expression (1) can result in improvement in the effect of reducing an excess amount of the molten metal sticking to the steel strip.

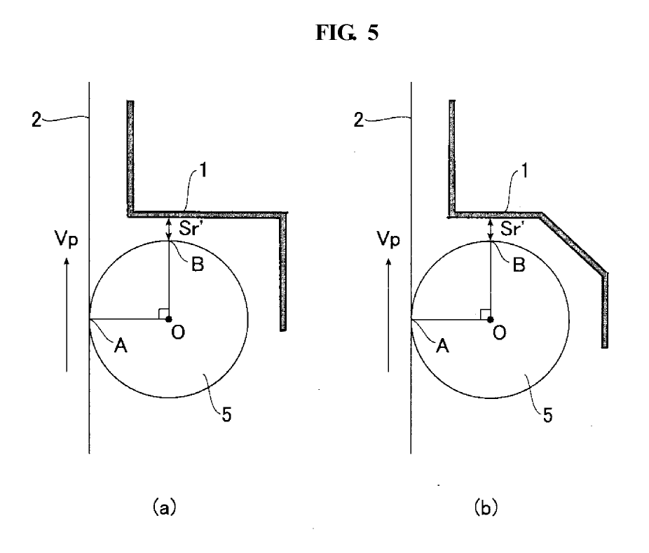

In the case where the portion of each of the rectifying plates 1 covering the submersed support rolls 5 does not have the arc shape as shown in FIG. 3 but has, for example, an inverted L shape in which a horizontal portion is connected to a vertical portion as shown in FIG. 5(a) or a shape in which an inclined portion is arranged between a horizontal portion and a vertical portion as shown in FIG. 5(b), the portion has a low pressure loss to reduce the effect. By replacing Sr with the minimum distance Sr′ between each rectifying plate 1 and the periphery of the corresponding submersed support roll 5 nearer to the steel strip and the molten metal surface (in FIGS. 5(a) and (b), the arc portion of a quadrant AOB, wherein AO is perpendicular to a steel strip surface, and BO is parallel to the steel strip surface) as a representative distance in the expression (1), the effect can be roughly calculated.

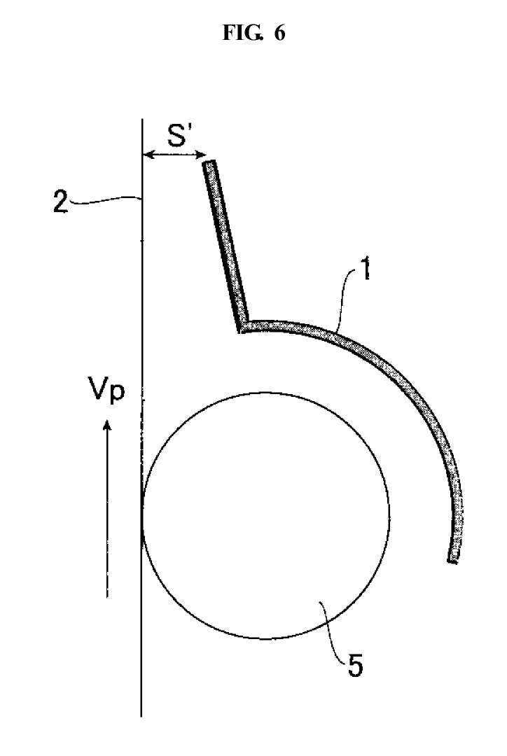

In the case where the portion of each rectifying plate 1 facing the steel strip 2 does not have the shape parallel to the steel strip surface as shown in FIG. 3 but has, for example, a shape tilted with respect to the steel strip surface in the travel direction as shown in FIG. 6, the effect can be roughly calculated by replacing S with the minimum distance S′ between the steel strip 2 and the rectifying plates 1 as a representative distance and replacing L with the projected length of the steel-strip-facing portion of the rectifying plate 1 in the travel direction of the steel strip when the steel-strip-facing portions of the rectifying plate 1 is projected on the steel strip surface in the expression (1).

### Examples

The apparatus for producing a hot-dip metal coated steel strip shown in FIG. 2 was installed in a continuous hot-dip galvanizing line. An experiment for producing a hot-dip galvanized steel strip was performed. The rectifying plates 1 were attached to frames of the submersed support rolls 5 and thus could not be moved during the operation of the line.

In the continuous hot-dip galvanizing line, the amount of offset of the submersed support rolls arranged on both sides of the steel strip 2 was 200 mm in the vertical direction. The distance between the molten metal surface and the top of the submersed support roll closer to the molten metal surface was 80 mm. In view of the arrangement of peripheral equipment, the distance Sr between each of the submersed support rolls 5 and a corresponding one of the rectifying plates 1 was 20 mm. The distance S between the steel strip 2 and the rectifying plates 1 was fixed to 30 mm. Alternatively, the steel-strip-facing portion of each rectifying plate had a tilted shape in which the top was 20 mm and the bottom was 30 mm apart from the steel strip. The portions of the rectifying plates 1 parallel to the steel strip extended so as to be 30 mm apart from the surface of molten zinc. The portions of the rectifying plates 1 covering the submersed support rolls 5 had an arc shape. The length of the rectifying plates 1 in the direction of the width of the steel strip was 2,000 mm comparable to that of the gas wiping nozzles. The submersed support rolls had a diameter D of 400 mm.

Conditions for producing the hot-dip metal coated steel strip were as follows: the slit gap of each gas wiping nozzle: 0.8 mm, gas wiping nozzle-steel strip distance: 7 mm, nozzle height from the molten zinc surface: 400 mm, and the temperature of the molten zinc bath: 460° C. The steel strip to be produced had a thickness of 0.8 mm, a width of 1.2 m, and a coating weight of 45 g/m² per side. Table 1 shows other production conditions, the length Lr of the portion of each rectifying plate 1 covering the periphery of the corresponding submersed support roll 5 near to the molten zinc surface, the minimum distance S between the steel strip and the rectifying plates, the length L of the steel-strip-facing portion of the corresponding rectifying plate, the minimum distance Sr between each submersed support roll and the corresponding rectifying plate, and the amount of splash serving as a product quality index. The amount of splash is defined as the ratio of the length of the steel strip determined as a strip having splash defects to the length of the steel strip fed under such production conditions. The resulting steel strips contained practically negligible splash defects.

TABLE 1

| | Operation | | | Length Lr of portion of | |
|---|---|---|---|---|---|
| | conditions | | | rectifying plate covering | Minimum distance S |
| | Wiping | Threading | Rectifying | periphery of support roll | between steel strip |
| | pressure | speed Vp | plate | near to molten zinc surface | and rectifying plate |
| Example 1 | 0.6 kgf/cm² | 2.5 m/sec | Attached | 400 mm | 30 mm |
| Example 2 | 0.6 kgf/cm² | 2.5 m/sec | Attached | 600 mm | 30 mm |
| Example 3 | 0.6 kgf/cm² | 2.5 m/sec | Attached | 400 mm | 30 mm |
| Example 4 | 1.0 kgf/cm² | 4.0 m/sec | Attached | 400 mm | 30 mm |
| Example 5 | 0.6 kgf/cm² | 2.5 m/sec | Attached | 400 mm | 80 mm |
| Comparative | 0.6 kgf/cm² | 2.5 m/sec | None | — | — |
| Example 1 | | | | | |
| Comparative | 1.0 kgf/cm² | 4.0 m/sec | None | — | — |
| Example 2 | | | | | |

| | | Minimum distance Sr | | | |
|---|---|---|---|---|---|
| | Length L of steel- | between submersed | | | |
| | strip-facing portion | support roll and | | | Splash |
| | of rectifying plate | rectifying plate | Lr*Sr | L*S | ratio |
| Example 1 | 120 mm | 30 mm | 12000 | 3600 | 0.37% |
| Example 2 | 120 mm | 30 mm | 18000 | 3600 | 0.21% |
| Example 3 | 220 mm | 40 mm | 16000 | 8800 | 0.41% |
| Example 4 | 220 mm | 40 mm | 16000 | 8800 | 0.83% |
| Example 5 | 220 mm | 40 mm | 16000 | 17600 | 0.92% |
| Comparative | — | — | — | | 1.40% |
| Example 1 | | | | | |
| Comparative | — | — | — | | 30.2% |
| Example 2 | | | | | |

Examples 1 and 2 were different in the length Lr of the portion of each rectifying plate 1 covering the periphery of the corresponding submersed support roll 5 near to the molten zinc surface. In both cases, the significant effect of reducing splashing was provided compared with Comparative Example 1. In Example 3, the steel-strip-facing portion of each rectifying plate 1 had the tilted shape in which the top was 20 mm and the bottom was 30 mm apart from the steel strip. In this case, the significant effect of reducing splashing was provided compared with Comparative Example 1. In Example 4 and Comparative Example 2, the threading speed was set to as high as 4.0 m/s. In Comparative Example 2, splashing occurred frequently; hence, the operation could not be performed. In contrast, in Example 4, the operation could be performed at a high quality level compared with that of the current operation at 2.5 m/s.

The apparatus can be used as equipment for producing a hot-dip metal coated steel strip having excellent appearance by reducing the occurrence of splashing. The apparatus can inhibit the occurrence of splashing even at high-speed threading and thus can be used as an apparatus for producing a hot-dip metal coated steel strip having excellent appearance with high productivity.

1. An apparatus for producing a hot-dip metal coated steel strip, the apparatus being configured to control a thickness of a coating metal by blowing a gas from wiping nozzles to a steel strip continuously drawn from a coating bath, and the wiping nozzles being arranged above the coating bath and facing the respective surfaces of the steel strip, comprising:
rectifying plates arranged on respective sides of the steel strip located above submersed support rolls and below a surface of a molten metal while not being in contact with the steel strip and the submersed support rolls, each of the rectifying plates having a roll-covering portion and a steel-strip-facing portion, each of the roll-covering portions being arranged to cover ¼ or more of the periphery of a corresponding one of the submersed support rolls near to the molten metal surface, each of the steel-strip-facing portions being arranged above a corresponding one of the submersed support rolls and facing the steel strip, and the steel-strip-facing portions of the rectifying plates being connected to the respective steel-strip-side ends of the roll-covering portions.

2. The apparatus according to claim 1, wherein a minimum distance between the roll-covering portion of each rectifying plate and a corresponding one of the submersed support rolls is 100 mm or less, and a minimum distance between the steel-strip-facing portions of the rectifying plates and the steel strip is 100 mm or less.

3. The apparatus according to claim 1, wherein a distance between the top of the steel-strip-facing portion of each rectifying plate and the surface of the molten metal is 100 mm or less.

4. The apparatus according to claim 1, wherein Lr*Sr≧S*L is satisfied, where S [mm] represents a minimum distance between the steel strip and the rectifying plates, Sr [mm] represents a minimum distance between each submersed support roll and a corresponding one of the rectifying plates, Lr [mm] represents the arc length of the periphery of each submersed support roll near to the molten metal surface, the periphery being covered with a corresponding one of the rectifying plates, and L [mm] represents the length of the steel-strip-facing portion of each rectifying plate.

5. The apparatus according to claim 2, wherein a distance between the top of the steel-strip-facing portion of each rectifying plate and the surface of the molten metal is 100 mm or less.

6. The apparatus according to claim 2, wherein Lr*Sr≧S*L is satisfied, where S [mm] represents a minimum distance between the steel strip and the rectifying plates, Sr [mm] represents a minimum distance between each submersed support roll and a corresponding one of the rectifying plates, Lr [mm] represents the arc length of the periphery of each submersed support roll near to the molten metal surface, the periphery being covered with a corresponding one of the rectifying plates, and L [mm] represents the length of the steel-strip-facing portion of each rectifying plate.

7. The apparatus according to claim 3, wherein Lr*Sr≧S*L is satisfied, where S [mm] represents a minimum distance between the steel strip and the rectifying plates, Sr [mm] represents a minimum distance between each submersed support roll and a corresponding one of the rectifying plates, Lr [mm] represents the arc length of the periphery of each submersed support roll near to the molten metal surface, the periphery being covered with a corresponding one of the rectifying plates, and L [mm] represents the length of the steel-strip-facing portion of each rectifying plate.

8. The apparatus according to claim 5, wherein Lr*Sr≧S*L is satisfied, where S [mm] represents a minimum distance between the steel strip and the rectifying plates, Sr [mm] represents a minimum distance between each submersed support roll and a corresponding one of the rectifying plates, Lr [mm] represents the arc length of the periphery of each submersed support roll near to the molten metal surface, the periphery being covered with a corresponding one of the rectifying plates, and L [mm] represents the length of the steel-strip-facing portion of each rectifying plate.
